(19) United States
(12) Patent Application Publication
(10) Pub. No.: US 2026/0138512 A1
(43) Pub. Date: May 21, 2026

(54) SEAT SUPPORT STRUCTURE OF VEHICLE

(71) Applicant: TOYOTA JIDOSHA KABUSHIKI KAISHA, Toyota-shi (JP)

(72) Inventor: Koki UNO, Sunto-gun (JP)

(73) Assignee: TOYOTA JIDOSHA KABUSHIKI KAISHA, Toyota-shi (JP)

(21) Appl. No.: 19/278,010

(22) Filed: Jul. 23, 2025

(30) Foreign Application Priority Data
Nov. 15, 2024 (JP) 2024-199731

(51) Int. Cl. B60N 2/427; B60N 2/42

(52) U.S. Cl. CPC B60N 2/42736; B60N 2/4214

(57) ABSTRACT

A seat support structure of a vehicle according to the present disclosure includes, in the seat support structure of the vehicle that includes a seat surface swingable along a curve rail, a pair of guide rollers in contact with the curve rail, and a cover provided outward of the guide rollers in a swinging direction and covering the curve rail. In a case where a large load is applied as at the time of a collision, the curve rail is largely displaced, but the cover comes into contact with the curve rail to receive the load, and thus an amount of deformation can be suppressed or a swing mechanism portion can be prevented from being damaged.

### CROSS-REFERENCE TO RELATED APPLICATION

This application claims priority to Japanese Patent Application No. 2024-199731 filed on Nov. 15, 2024. The disclosure of the above-identified application, including the specification, drawings, and claims, is incorporated by reference herein in its entirety.

### BACKGROUND

### 1. Technical Field

The present disclosure relates to a seat support structure of a vehicle.

### 2. Description of Related Art

Japanese Unexamined Patent Application Publication No. 2019-156143 (JP 2019-156143 A) discloses a seat support structure of a vehicle that can move a seat to an optimum swing position in a lateral direction or a front-rear direction without rotating the seat in a yaw direction.

### SUMMARY

When a large load is applied as at the time of a collision, the large load is received by a portion (roller or the like) guiding a swing. In the related art, there is a possibility that the swing is not possible at the time of the collision.

The present disclosure has been made to solve the above problems. An object of the present disclosure is to provide a seat support structure of a vehicle capable of suppressing deformation in a case where a large load is applied as at the time of a collision.

A seat support structure of a vehicle according to the present disclosure is a seat support structure including,
in the seat support structure of the vehicle that includes a seat surface swingable along a curve rail,
a pair of guide rollers in contact with the curve rail, and
a cover provided outward of the guide rollers in a swinging direction and configured to cover the curve rail.

According to the present disclosure, it is possible to provide the seat support structure of the vehicle capable of suppressing the deformation in a case where the large load is applied as at the time of the collision.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a seat support structure of a vehicle according to Embodiment 1;

FIG. 2 is a front view of a seat support structure; and

FIG. 3 is a front sectional view of the seat support structure cut at the center of the second curve rail.

### DETAILED DESCRIPTION OF EMBODIMENTS

Hereinafter, embodiments will be described with reference to the drawings. Common or corresponding elements in each of the drawings are denoted by the same reference numerals, and the description thereof will be simplified or omitted. The configuration shown in the embodiment shown below is an example of the technical idea according to the present disclosure, and can be combined with another known technique or can be combined with the plurality of technical ideas described in the present disclosure. In addition, a part of the configuration can be omitted or changed within the scope of the spirit of the present disclosure.

### Embodiment 1

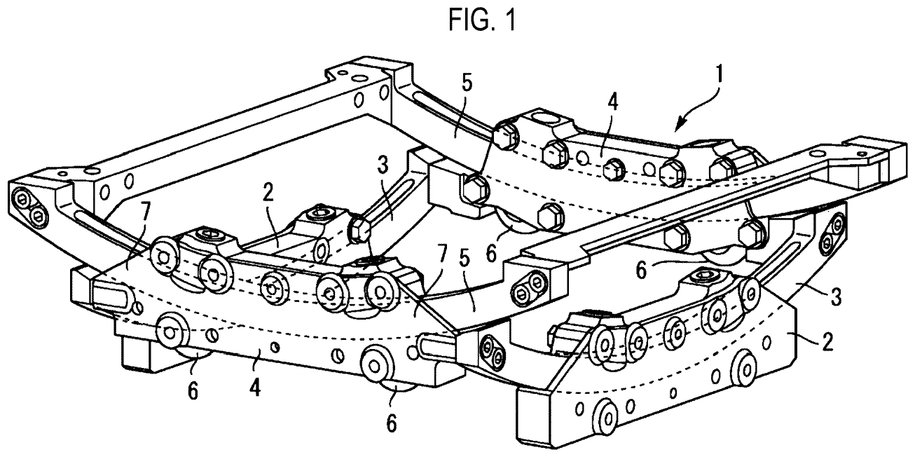

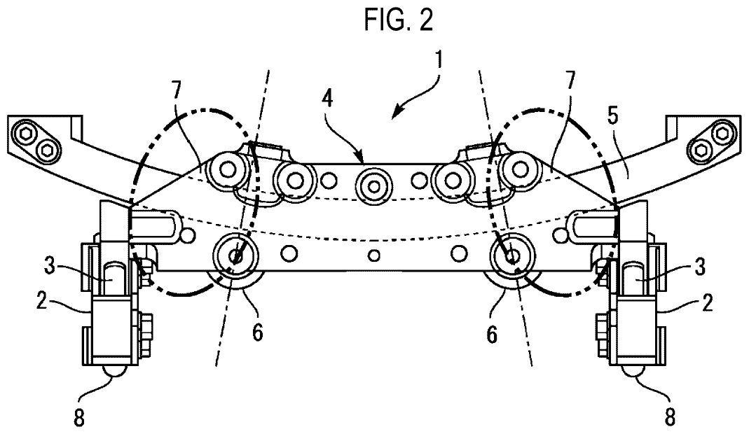

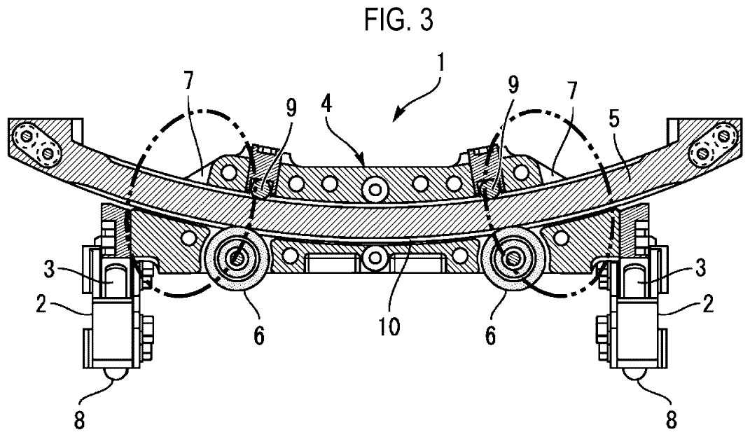

FIG. 1 is a perspective view showing a seat support structure 1 of a vehicle according to Embodiment 1. FIG. 2 is a front view of the seat support structure 1. FIG. 3 is a front sectional view of the seat support structure 1 cut at the center of the second curve rail 5. As shown in FIG. 1, a seat support structure 1 of a vehicle according to Embodiment 1 includes a seat surface swingable along a curve rail. The seat support structure 1 includes a pair of rail support portions 2, a pair of first curve rails 3 each having an arc shape, a pair of rail support portions 4, and a pair of second curve rails 5 each having an arc shape. The seat surface is fixed to the second curve rails 5. The pair of rail support portions 2 are fixed to a floor of a vehicle. The first curve rails 3 are supported by the rail support portions 2. The first curve rails 3 are curved such that an upper surface thereof is an inner periphery.

The rail support portions 2 support the first curve rails 3 such that the first curve rails 3 are swingable. The first curve rails 3 are movable in a longitudinal direction with respect to the rail support portions 2. The rail support portions 2 include a pair of guide rollers 8 in contact with the first curve rails 3 from the lower side. In a plan view, the first curve rails 3 are parallel to the front-rear direction. When the first curve rails 3 move with respect to the rail support portions 2, the seat surface swings in the front-rear direction.

The rail support portions 4 are fixed to each of both end portions of the pair of first curve rails 3. The rail support portions 4 support the second curve rails 5 to be swingable. The second curve rails 5 are movable in the longitudinal direction with respect to the rail support portions 4. The rail support portions 4 include a pair of guide rollers 6 in contact with the second curve rails 5 from the lower side. In a plan view, the second curve rails 5 are parallel to the left-right direction. When the second curve rails 5 move with respect to the rail support portions 4, the seat surface swings in the left-right direction. The second curve rails 5 are curved such that an upper surface thereof is an inner periphery.

As shown in FIGS. 2 and 3, the rail support portion 4 includes a cover 7 covering the second curve rail 5 from front to rear and from top to bottom. The cover 7 is provided outward of the guide rollers 6 in the swinging direction. The swinging direction is a longitudinal direction of the second curve rail 5. The one-dot chain lines in FIG. 2 are straight lines perpendicular to the second curve rail 5 at the contact points between the guide rollers 6 and the second curve rail 5. The outer side of the one-dot chain lines corresponds to the outer side in the swinging direction. The ellipses in FIGS. 2 and 3 mainly indicate regions outward of the guide rollers 6 in the swinging direction. In the regions outward of the guide rollers 6 in the swinging direction, the cover 7 covers the second curve rail 5 from the front-rear direction and the vertical direction that are directions other than the swinging direction of the second curve rail 5.

A large load may be applied as at the time of a collision. In such a case, in the present embodiment, the second curve rail 5 is greatly displaced. Meanwhile, the cover 7 comes into contact with the second curve rail 5 and receives a load. As a result, the amount of deformation can be suppressed or the swing mechanism portion can be prevented from being damaged. In a case where a large load is not applied as at the time of a collision, the second curve rail 5 is not in contact with the cover 7.

A cover similar to the cover 7 may be provided on the rail support portions 2 supporting the first curve rails 3. As a result, in a case where a large load is applied as at the time of a collision, the cover comes into contact with the first curve rails 3 largely displaced and receives the load, and thus the amount of deformation can be suppressed or the swing mechanism portion can be prevented from being damaged.

As shown in FIG. 3, pressing portions 9 pressing a ball or a roller against the upper surface of the second curve rails 5 with a force of a spring are provided at a position facing the guide rollers 6.

In the present embodiment, the groove 10 is provided on the lower surface of the second curve rail 5. The guide rollers 6 are in contact with the groove 10. As a result, even when a large load is applied as at the time of a collision, the guide rollers 6 are less likely to come off the second curve rail 5, and thus the amount of deformation can be suppressed or the swing mechanism portion can be prevented from being damaged.

What is claimed is:

1. A seat support structure of a vehicle that includes a seat surface swingable along a curve rail, the seat support structure comprising:
a pair of guide rollers in contact with the curve rail; and
a cover provided outward of the guide rollers in a swinging direction and configured to cover the curve rail.

2. The seat support structure according to claim 1, wherein:
a groove is provided on a lower surface of the curve rail; and
the guide rollers are in contact with the groove.
